(19) United States
(12) Patent Application Publication
(10) Pub. No.: US 2021/0301117 A1
(43) Pub. Date: Sep. 30, 2021

(54) EXTRUSION PROFILE FOR A WINDOW AND/OR DOOR PART AND MANUFACTURING METHOD

(71) Applicant: Salamander Industrie-Produkte GmbH, Tuerkheim (DE)

(72) Inventor: Till Schmiedeknecht, Muenchen (DE)

(73) Assignee: Salamander Industrie-Produkte GmbH, Tuerkheim (DE)

(21) Appl. No.: 17/214,244

(22) Filed: Mar. 26, 2021

(30) Foreign Application Priority Data
Mar. 27, 2020 (DE) 102020108599.0

(51) Int. Cl. C08L 27/06; E06B 3/22; B29C 48/285; C08J 3/22

(52) U.S. Cl. CPC C08L 27/06; E06B 3/22; B29K 2105/26; C08J 3/226; B29C 48/286

(57) ABSTRACT

An extrusion profile, such as a coextrusion profile or a monoextrusion profile, for a window and/or door part, such as a window and/or door frame part or a window and/or door wing part, may include at least one profile surface forming the outside of the extrusion profile that is made of a mixture. The mixture may include plastic and at least one pigmented cellulose or at least one mineral. The at least one pigmented cellulose or the at least one mineral may have a mass fraction between 1.0 wt.-% and 15.0 wt.-% of the mixture, in particular between 2.0 wt.-% and 10.0 wt.-% of the mixture.

### CROSS REFERENCE TO RELATED APPLICATIONS

This patent application claims priority to German Patent Application No. 10 2020 108 599.0, filed Mar. 27, 2020, which is incorporated herein by reference in its entirety.

### BACKGROUND

### Field

The present disclosure relates to an extrusion profile, such as a mono- or a coextrusion profile, for a window and/or door part, in particular a window- and/or doorframe part or a window and/or door wing part, and a method for manufacturing such a profile.

### Related Art

It is already known in the prior art to give plastic window frame profiles a specific look. Therefore for example laminated foils with the desired look or clipped on frame blinds, in particular made of aluminum, are used.

Further, from DE 20 2006 007 797 U1 a plastic window frame profile is known, that has a wood-like look. To achieve the wood-look, a polymer mixture comprising PVC and colorants is extruded. Subsequently the outside of the profile has to be brushed which leads to a removal of material, and finally be sealed with a hardening surface coating.

On the one hand, the look of the plastic window frame profiles according to DE 20 2006 007 797 U1 is limited to wood. On the other hand, the manufacturing process for the profiles is very complex, in particular as additional mechanical post-processing steps after the extrusion and further an additional sealing step are required, in order to manufacture the profile with the desired look. Plastic materials which are used in the prior art for window and/or door parts also have the disadvantage that they lack an environmentally friendly and CO2-neutral look, thus for example the look of a plastic recycling material. In the context of the present disclosure, plastic recycling material is understood, among others, as old, already installed plastic frames that are recycled after use, and plastic scrap material, which for example arises during the manufacturing process.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 an exemplary embodiment of a coextrusion profile according to the disclosure in a sectional view;

FIG. 2 an exemplary embodiment of a coextrusion profile according to the disclosure in a sectional view;

FIG. 3 an exemplary embodiment of a monoextrusion profile according to the disclosure in a sectional view;

FIG. 4 an exemplary embodiment of a monoextrusion profile according to the disclosure in a sectional view;

FIG. 5 a schematic representation of a section of a production line for a monoextrusion profile according to an exemplary embodiment of the disclosure in a side view;

FIG. 6 a schematic representation of a section of a production line for a monoextrusion profile according to the disclosure in a top view;

FIG. 7 a schematic representation of a section of a production line for a coextrusion profile according to an exemplary embodiment of the disclosure in a side view;

FIG. 8 a schematic representation of a V-shaped arrangement of the extruders of a production line for a coextrusion profile according to an exemplary embodiment of the disclosure in a top view;

FIG. 9 a schematic representation of a L-shaped arrangement of the extruders of a production line for a coextrusion profile according to an exemplary embodiment of the disclosure in a top view; and

FIG. 10 a schematic representation of an extrusion line for an extrusion profile according to an exemplary embodiment of the disclosure with two tools and three extruders in a top view.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

It is an object of the present disclosure to overcome the disadvantages of the known prior art, in particular to provide a plastic extrusion profile with a desired look, in particular a concrete-like look and/or the look of a plastic recycling material, which is easy to manufacture.

The above-mentioned object is solved according to a first aspect by providing an extrusion profile, in particular a coextrusion profile or a monoextrusion profile, for a door and/or window part, for example a door and/or window frame part or a door and/or window wing part, wherein at least one profile surface forming an outside of the extrusion profile is made of a mixture, the mixture comprising plastic and at least one pigmented cellulose or at least one mineral, and wherein the at least one pigmented cellulose or the at least one mineral has a mass fraction between 1.0 wt.-% and 15.0 wt.-% of the mixture, in particular between 2.0 wt.-% and 10.0 wt.-% of the mixture. The extrusion profile may for example at least partially form a door and/or window part, such as a spar, like a vertical spar or a horizontal spar, either of a stationary door and/or window frame part or of a movable, in particular slidable and/or pivotable, door and/or window wing part. The extrusion profile may comprise a semi-finished extrusion product initially manufactured by extrusion, which has an essentially identical cross section and an essentially identical outer dimension along the extrusion direction.

It was found that plastic recycling material has the advantage of being particularly environmentally friendly and CO2-neutral. In contrast, other plastic materials lack an environmentally friendly and CO2-neutral look, thus for example the look of a plastic recycling material. Extrusion profiles for window and/or door parts known in the prior art have the disadvantage that profile surfaces visible to the outside do not have the look of an environmentally friendly plastic recycling material. Therefore, there is principally a conflict of interests between on the one hand the desire to provide an extrusion profile for a window and/or door part made of plastic material and on the other hand to provide an extrusion profile for a window and/or door part, which has an environmentally friendly and CO2-neutral look, thus for example the look of a plastic recycling material, at least on the visible surfaces of the profile.

By the measures according to the disclosure, namely the manufacturing of the at least one profile surface forming the outside of the extrusion profile of a mixture, the mixture comprising plastic and at least one pigmented cellulose or at least one mineral, wherein the at least one pigmented cellulose or the at least one mineral has a mass fraction between 1.0 wt.-% and 15.0 wt.-% of the mixture, in particular between 2.0 wt.-% and 10.0 wt.-% of the mixture, this conflict of interests can be reliably solved in an economical manner. The measures according to the disclosure thus provide an extrusion profile for a window and/or door part, in particular for a window and/or door frame part or a window and/or door wing part, made of plastic, wherein at least one profile surface forming the outside of the extrusion profile has the particularly desired environmentally friendly and CO2-neutral look, thus the look of a plastic recycling material.

The manufacturing of the extrusion profile according to the disclosure is performed by a mono- or coextrusion process, in which the use of the at least one pigmented cellulose or the at least one mineral can be limited to a single layer of the at least one profile surface forming the outside of the extrusion profile. The individual steps of the manufacturing process will be discussed in detail later. In the context of this disclosure, the term “monoextrusion profile” shall be understood as a profile manufactured by monoextrusion. The term “coextrusion profile” shall be understood as a profile manufactured by coextrusion. Coextrusion refers to the merging of two plastic melts of the same or different types prior to leaving the extrusion tool (nozzle), wherein the two plastic melts are generated by two separate extrusion lines and combined in the extrusion tool (nozzle) to form a single work piece. According to the disclosure, the two plastic melts are combined to form an extrusion profile.

In an exemplary embodiment, the layer of the at least one pigmented cellulose or the at least one mineral is located on the visible surface of the profile. In an exemplary embodiment, a layer of the at least one pigmented cellulose or the at least one mineral is applied to the visible surface of the extrusion profile, wherein a smaller amount of the at least one pigmented cellulose or the at least one mineral is required. This reduces the costs for manufacturing an extrusion profile according to the disclosure.

In general, the addition of substances such as at least one pigmented cellulose or at least one mineral to a profile can reduce the strength of the profile. Therefore, according to the disclosure, the extrusion profile is manufactured by means of a coextrusion process, as the corner strength of an extrusion profile can be sufficiently ensured by means of a coextrusion process even when additives are used. The coextrusion process enables the application of a thin layer of the at least one pigmented cellulose or the at least one mineral. It is of great advantage for this disclosure that by applying a thin layer of the at least one pigmented cellulose or the at least one mineral, the addition of the at least one pigmented cellulose or the at least one mineral does not have a noticeable strength-reducing effect on the profile, as the addition can be reduced to a single, very thin layer. Therefore, the profiles manufactured according to the disclosure have a sufficient strength both in the welding area as well as against impact and fracture.

The at least one profile surface forming the outside of the extrusion profile for a door and/or window frame part is preferably made of a mixture comprising plastic and at least one pigmented cellulose or comprising plastic and at least one mineral.

In the context of this disclosure, the term “at least one” shall be understood as at least a single substance or a single molecule, or 2, 3, 4, 5, 6, 7, 8, 9, 10, 11, 12, 13, 14, 15, 16, 17, 18, 19, 20, or any number of substances or molecules. Thus, in the context of this disclosure, for example the term “at least one pigmented cellulose” shall be understood as at least one pigmented cellulose, or 2, 3, 4, 5, 6, 7, 8, 9, 10, 11, 12, 13, 14, 15, 16, 17, 18, 19, 20, or any number of pigmented celluloses. Further, in the context of this disclosure for example the term “at least one mineral” shall be understood as at least one mineral, or 2, 3, 4, 5, 6, 7, 8, 9, 10, 11, 12, 13, 14, 15, 16, 17, 18, 19, 20, or any number of minerals. Additionally, in the context of this disclosure, the term “at least one” includes any number of substances or molecules, which are preferably evenly distributed within a layer or on a surface. In the context of the disclosure, however the term “at least one” shall also include any number of substances or molecules that are unevenly distributed within a layer or on a surface.

In an exemplary embodiment, the pigmented cellulose is a pigmented cellulose mixture comprising cellulose and at least one pigment. In an exemplary embodiment, the pigmented cellulose, comprising at least cellulose and at least one pigment, has a mass fraction between 1 wt.-% and 10 wt.-% of the mixture, in particular between 3 wt.-% and 7 wt.-% of the mixture, between 4 wt.-% and 6 wt.-% of the mixture or approximately 5 wt.-% of the mixture. In the context of this disclosure, the term “at least one pigmented cellulose” also includes a combination of different pigmented celluloses. Thus in the context of this disclosure, the term “at least one pigmented cellulose” may, besides a single pigmented cellulose, also include 2, 3, 4, 5, 6, 7, 8, 9, 10, 11, 12, 13, 14, 15, 16, 17, 18, 19, 20, or any number of different pigmented celluloses. Thus, the pigmented celluloses used according to the disclosure can differ for example in the combination of celluloses and different pigments.

In the context of this disclosure, the term “approximately” is used to indicate a certain tolerance. According to the disclosure, “approximately” means±10.0%, or ±5.0%, or ±1.0%, or ±0.5%, or ±0.1%.

In an exemplary embodiment, the mineral of the mixture is selected from magnesium silicate, aluminum magnesium silicate, potassium aluminum silicate, mica, MicaCelia, graphite, slate and/or glass fiber, in particular wherein the mineral is magnesium silicate. In the context of this disclosure, the term “at least one mineral” also includes a combination of the preferred minerals. Thus in the context of this disclosure, the term “at least one mineral” may, besides a single mineral, also include 2, 3, 4, 5, 6, 7, 8, 9, 10, 11, 12, 13, 14, 15, 16, 17, 18, 19, 20, or any number of different minerals. In the context of this disclosure, mica shall preferably refer to magnesium silicate.

In an exemplary embodiment, the mineral of the mixture has a mass fraction between 1.0 wt.-% and 10.0 wt.-% of the mixture, in particular between 2.0 wt.-% and 5.0 wt.-% of the mixture or approximately 2.5 wt.-% of the mixture.

In an exemplary embodiment, the at least one profile surface forming the outside of the extrusion profile for a door and/or window frame part is made of a mixture comprising plastic and at least one mineral. In a further example embodiment, in addition to the plastic and the at least one mineral, the mixture also comprises at least one pigment.

In an exemplary embodiment, the mineral and the at least one pigment of the mixture have a mass fraction between 1.0 wt.-% and 10.0 wt.-% of the mixture, in particular between 2.0 wt.-% and 5.0 wt.-% of the mixture or approximately 2.5 wt.-% of the mixture.

In an exemplary embodiment, a mixture comprising plastic and at least one pigmented cellulose, which comprises at least cellulose and at least one pigment, or comprising plastic, at least one mineral and at least one pigment is used. According to the disclosure, any pigment can be used. Particularly preferably, a pigment in RAL (Reichs-Ausschuß für Lieferbedingungen and Gütesicherung) 7023, RAL 7000, RAL 7001, RAL 7002, RAL 7003, RAL 7004, RAL 7005, RAL 7006, RAL 7008, RAL 7009, RAL 7010, RAL 7011, RAL 7012, RAL 7013, RAL 7015, RAL 7016, RAL 7021, RAL 7022, RAL 7024, RAL 7026, RAL 7030, RAL 7031, RAL 7032, RAL 7033, RAL 7034, RAL 7035, RAL 7036, RAL 7037, RAL 7038, RAL 7039, RAL 7040, RAL 7042, RAL 7043, RAL 7044, RAL 7045, RAL 7046, RAL 7047 and/or RAL 7048 is used. Particularly preferably the pigment is used for coloration, in particular a gray, more preferably a “concrete gray” coloration of the at least one profile surface forming the outside of the extrusion profile, in particular of the coextrusion profile or the monoextrusion profile, for a door and/or window frame part. The use of a pigment in a shade of gray is preferred, as its addition enables the manufacturing of an extrusion profile for a door and/or window part with the look of an extrusion profile made of plastic recycling material, thus of an extrusion profile with a particularly environmentally friendly and CO2-neutral look. In particular preferred is the use of a pigment in RAL 7023.

An exemplary embodiment relates to an extrusion profile, in particular a coextrusion profile or a monoextrusion profile, for a door and/or window frame part, in particular a door and/or window frame, wherein at least one profile surface forming the outside of the extrusion profile is made of a mixture, the mixture comprising plastic and at least one RAL 7023 pigmented cellulose, and wherein the at least one RAL 7023 pigmented cellulose has a mass fraction between 1 wt.-% and 10 wt.-% of the mixture, in particular between 3 wt.-% and 7 wt.-% of the mixture, between 4 wt.-% and 6 wt.-% of the mixture or approximately 5 wt.-% of the mixture.

In an exemplary embodiment, the at least one pigmented cellulose or the at least one mineral provides the at least one profile surface forming the outside of the extrusion profile, in particular of the coextrusion profile or the monoextrusion profile, for a door and/or window frame part, with a haptically perceptible and/or optically visible surface. In an exemplary embodiment, the at least one pigmented cellulose or the at least one mineral provide the at least one profile surface forming the outside of the extrusion profile with a concrete-like haptically perceptible surface and/or with a concrete-like optically visible surface. The provision of a concrete-like haptically perceptible and/or concrete-like optically visible surface is preferred, as it enables the provision of an extrusion profile with a haptically perceptible and/or optically visible surface of the profile made of plastic recycling material.

In an exemplary embodiment, the plastic of the mixture is a plastic recycling material comprising an used-window-granulate or a mixture comprising plastic and at least one additive, wherein the used-window-granulate or the mixture comprising plastic and at least one additive has a mass fraction between 70 wt.-% and 100 wt.-% of the mixture, in particular between 80 wt.-% and 99 wt.-% of the mixture, between 90 wt.-% and 98 wt.-% of the mixture or approximately 95 wt.-% of the mixture.

In the context of this disclosure, “used-window-granulate” refers to a mixture that consists of old, previously installed plastic frames that are recycled after use, and/or consists of plastic material that arises during the manufacturing process for example at the window manufacturer, or when the old window is removed. In the context of this disclosure, the old, previously installed plastic frames and/or the plastic material that arises during the manufacturing process for example at the window manufacturer, or when the old window is removed, can be mixed with one another during the preparation of used-window-granulate. The old, already installed plastic frames and/or the plastic material that arises during the manufacturing process for example at the window manufacturer, or when the old window is removed can also be provided separately.

In an exemplary embodiment, a plastic recycling material is used for an extrusion profile according to the disclosure. An extrusion profile made of a plastic recycling material is particularly advantageous because it is beneficial for the environment as it is a CO2-neutral product. By the measures according to the disclosure it is possible to provide an extrusion profile for window and/or door parts, in which plastic recycling material is used for profile surfaces visible to the outside, so that the environmental compatibility of the extrusion profiles according to the disclosure can be seen from outside.

In an exemplary embodiment, the used-window-granulate is a material manufactured by a process comprising the following steps:
i) Comminution of used-window material, in particular wherein the comminution comprises the grinding or shredding of used-window material;
ii) Separating the comminuted used-window material;
iii) Sorting the separated and comminuted used-window material into different color shades;
iv) Optionally, pigmenting the sorted, separated and comminuted used-window material;
v) Cleaning the pigmented, sorted, separated and comminuted used-window material, wherein the cleaning is preferably performed by melt filtration, and
vi) Granulating the cleaned, pigmented, sorted, separated and comminuted used-window material.

In step ii) of the process, physical separation processes or optical-physical separation processes, that are familiar to the person skilled in the art, are preferably employed for separating, to separate different components, for example different metals and plastics (such as EPDM, TPE, ASA, ABS) from the window PVC regrind. In a preferred embodiment, for example, iron is separated from non-iron components. In a further preferred embodiment, ceramic components are separated from plastics.

In step iii) of the process, the separated and comminuted used-window material is preferably sorted into the purest possible color shades. In an exemplary embodiment, the separated and comminuted used-window material is sorted into shades of white, shades of brown and color shades. In an exemplary embodiment, the sorting in step iii) of the process is performed by optical color sorting methods that are familiar to the person skilled in the art.

The used-window-granulate manufactured by the process is further processed according to the disclosure in order to obtain a concrete-like look and/or the look of a plastic recycling material. The concrete look and/or the look of a plastic recycling material of the used-window-granulate is achieved by addition of additives, such as the at least one pigmented cellulose or the at least one mineral, in the profile extrusion. The addition of additives, such as the at least one pigmented cellulose or the at least one mineral, in the profile extrusion is preferably performed by a metering device in the material feeding, for example in a funnel, of the extruder or by adding the additives in an upstream mixing area.

A pigmentation in the manufacturing of used-window-granulate before the melt filtration can be problematic, as it limits the particle size of the pigments by the mesh size of the melt filtration. Therefore, in an exemplary embodiment the pigmentation in the manufacturing of used-window-granulates is performed after the melt filtration.

In an exemplary embodiment, the mixture comprises waste products or profile sections that arise during the extrusion of the profile, for example of a profile for a door and/or a window frame part, in particular a door and/or a window frame. The waste products or profile sections are, according to the disclosure, processed similar to the used-window-granulate.

In an exemplary embodiment, the at least one additive of the mixture comprising plastic and at least one additive is calcium carbonate, titanium (IV) oxide, a modifier, such as acrylate and/or chlorinated polyethylene (CPE), a stabilizer, a metal soap, a lubricant, a stearate, a fatty acid and/or a pigment. Further, the at least one additive can be a flame retardant, a UV absorber, a propellant, an adhesion agent, an antistatic agent and/or a fungicide.

In an example embodiment, the at least one additive of the mixture comprising plastic and at least one additive is selected from the group consisting of:
(i) a mineral filler, such as calcium carbonate, talc, mica, wollastonite, silica, kaolin, magnesium silicate, aluminum magnesium silicate, potassium aluminum silicate, Mica, MicaCelia, graphite, slate, glass fiber, or dolomite,
(ii) a mineral pigment, such as titanium (IV) oxide (TiO2), zirconium (II) oxide (ZrO), cerium (III) oxide (Ce2O3), cadmium sulfide (CdS), calcium ascorbate (CaAs), zirconium (IV) oxide (ZrO2), iron (I) oxide (Fe2O), iron (II) oxide (FeO), iron (III) oxide (Fe2O3), or silicon dioxide (SiO2),
(iii) a polyesterizing polymer compound,
(iv) a copolymer, such as a copolymer of the ethylene with vinyl acetate (EVA),
(v) a lubricant, such as glycerin, a fatty alcohol, a fatty acid, a paraffin oil, a paraffin, polyethylene, a fatty acid amide or a silicone oil,
(vi) a polyvinyl chloride, such as K65 polyvinyl chloride, K66 polyvinyl chloride, K67 polyvinyl chloride, K68 polyvinyl chloride, or K69 polyvinyl chloride; and
(vii) an ester, such as phthalic acid ester (phthalate), diallyl phthalate, di-2-ethylhexyl phthalate, di-isooctyl phthalate, or tetrabrom dioctyl phthalate.

In the context of this disclosure, any commercially available mineral filler can be used. Preferably calcium carbonate, talc, mica, wollastonite, silica, kaolin, magnesium silicate, aluminum magnesium silicate, potassium aluminum silicate, mica, MicaCelia, graphite, slate, such as slate powder, slate grain, or expanded slate, glass fiber or dolomite is used as mineral filler.

In the context of this disclosure, any commercially available mineral pigment can be used. Preferably, the mineral pigment is selected from titanium (IV) oxide (TiO2), zirconium (II) oxide (ZrO), cerium (III) oxide (Ce2O3), cadmium sulfide (CdS), calcium ascorbate (CaAs), zirconium (IV) oxide (ZrO2), iron (I) oxide (Fe2O), iron (II) oxide (FeO), iron (III) oxide (Fe2O3), and silicon dioxide (SiO2).

In the context of this disclosure, any commercially available modifier can be used. Preferably, the modifier is selected from chlorinated polyolefins, such as chlorinated polyethylene (CPE), polymers of the acrylate type, such as homo- and copolymers of acrylic acid alkyl esters, acrylate, ethylene-propylene-rubbers, impact modifiers of the butadiene type, such as acrylonitrile-butadiene-styrene (ABS) and/or methacrylate-acid-methyl-ester-butadiene-styrene (MBS), and copolymers of ethylene with vinyl acetate (EVA).

In the context of this disclosure, any commercially available stabilizer can be used. Preferably, the stabilizer is selected from inorganic stabilizers based on Cd, Pb, Mg, Sn, Zn, Ca or Ba, for example a metal soap, such as a barium cadmium soap, a calcium-zinc soap or a lead soap, a lead salt, an alkyl tin mercapto compound, an alkyl tin carboxylate, or from organic stabilizers such as an epoxidized oil or ester, a diphenyl thiourea, phenylindole, a phenol, a bisphenol, an aryl phosphite, an alkyl phosphite or an aryl-alkyl phosphite.

Preferably a neutral or a basic metal soap is used, the metal soap being particularly preferably selected from a metal soap based on Cd, Pb, Mg, Sn, Zn, Ca and Ba, for example a barium cadmium soap, a calcium-zinc soap and a lead soap.

In the context of this disclosure, any lubricant can be used, in particular a lubricant such as glycerin, a fatty alcohol with a chain length from C12 to C40, a monoester, a diester or a tri-ester of natural or oxidized carboxylic acids with a chain length of C12 to C40, a fatty acid with a chain length from C12 to C40, a substituted fatty acid, an oxidized fatty acid, a paraffin oil, a solid paraffin, polyethylene, an oxidized polyethylene, a fatty acid amid and a silicone oil.

Preferably, stearates of the metals Cd, Pb, Mg, Sn, Zn, Ca or Ba, phthalic acid esters of long-chain alcohols or wax esters, such as C10 to C40-alcohols esterified with C12 to C36-acids, are used. In the context of this disclosure, any fatty acid, in particular fatty acids with chain length from C12 to C40 can be used.

Preferably, a pigment is used as additive, which gives the mixture a desired coloration.

In the context of this disclosure, any commercially available polyesterizing polymer compound can be used. In the context of this disclosure, also any commercially available copolymer can be used. Preferably, a copolymer of ethylene with vinyl acetate (EVA) is used. In the context of this disclosure, also any commercially available polyvinyl chloride can be used. Preferably, the polyvinyl chloride is used as supporting material, wherein the polyvinyl chloride particularly preferably is K65 polyvinyl chloride, K66 polyvinyl chloride, K67 polyvinyl chloride, K68 polyvinyl chloride or K69 polyvinyl chloride.

In the context of this disclosure, any ester can be used. In an exemplary embodiment, the ester is selected from phthalic acid ester (phthalate), diallyl phthalate, di-2-ethylhexyl phthalate, di-isooctyl phthalate and tetrabrom dioctyl phthalate. Preferably, the phthalate is free of plasticizers.

In an exemplary embodiment, the mixture comprises at least one mineral pigment, such as titanium (IV) oxide (TiO2), a mineral filler, a polyesterizing polymer compound, a polyvinyl chloride, and/or an ester, for example phthalic acid ester (phthalate).

In an exemplary embodiment, the mixture comprises used-window-granulate and grist. Particularly preferably, the grist is a postindustrial material.

In an exemplary embodiment, the mixture comprising plastic and at least one additive is a “dry blend” mixture. In the context of this disclosure, the term “dry blend” shall be understood as a mixture comprising plastic and at least one additive. Particularly preferably the dry blend mixture consists of at least one plastic, in particular polyvinyl chloride plastic, calcium carbonate, titanium (IV) oxide, at least one modifier, at least one stabilizer, at least one metal soap, at least one lubricant, at least one stearate, and/or at least one fatty acid. In a further preferred embodiment, the dry blend mixture can comprise at least one pigment. The addition of at least one pigment enables a desired coloration of the mixture.

In an exemplary embodiment, a mixture is used, the mixture comprising used-window-granulate and grist, wherein the ratio of used-window-granulate to grist is approximately 30-70%, or approximately 40-60%, or approximately 50-50%, or approximately 60-40%, or approximately 70-30%, or approximately 80-20%.

In an exemplary embodiment, the plastic is a polyvinyl chloride plastic.

In an exemplary embodiment, the metering of the at least one pigmented cellulose or the at least one mineral has been performed by adding the at least one pigmented cellulose or the at least one mineral to the plastic via a metering device, for example a volumetric and/or a gravimetric metering device.

The above-mentioned object is solved according to a second aspect by providing a method for manufacturing an extrusion profile in which at least one profile surface forming an outside of the extrusion profile is manufactured by means of extrusion, in particular by means of coextrusion or monoextrusion, of a mixture, the mixture comprising plastic and at least one pigmented cellulose or at least one mineral, wherein the at least one pigmented cellulose or the at least one mineral has a mass fraction between 1.0 wt.-% and 15.0 wt.-% of the mixture, in particular between 2.0 wt.-% and 10.0 wt.-% of the mixture.

In an exemplary embodiment, the extrusion profile is manufactured with a coextrusion process, as by coextrusion the use of the at least one pigmented cellulose or the at least one mineral can be limited to a single layer of the at least one profile surface forming the outside of the extrusion profile. This layer is preferably located on the visible surface of the profile. Particularly preferably a layer of the at least one pigmented cellulose or the at least one mineral is applied on the visible surface of the extrusion profile, wherein a smaller amount of the at least one pigmented cellulose or the at least one mineral is required. This reduces the costs for manufacturing an extrusion profile according to the disclosure. In addition, the strength of the profile in the welding area, as well as the strength of the profile against impact and fracture increase.

In an exemplary embodiment, the method for manufacturing an extrusion profile includes the step of metering the at least one pigmented cellulose or the at least one mineral, wherein the metering of the at least one pigmented cellulose or the at least one mineral is performed by adding the at least one pigmented cellulose or the at least one mineral to the plastic via a metering device, for example a volumetric and/or a gravimetric metering device.

The present disclosure also provides a door and/or window frame as well as a door and/or window wing, which has at least one spar manufactured by a method according to the disclosure or formed by a profile according to the disclosure.

According to another aspect of the present disclosure, which can be combined with the preceding aspects and example embodiments, the above-mentioned object is solved according to a further aspect by providing the use of at least one pigmented cellulose or at least one mineral for coloration and structuring of an extrusion profile, wherein the coloration and structuring of a plastic recycling material is preferred.

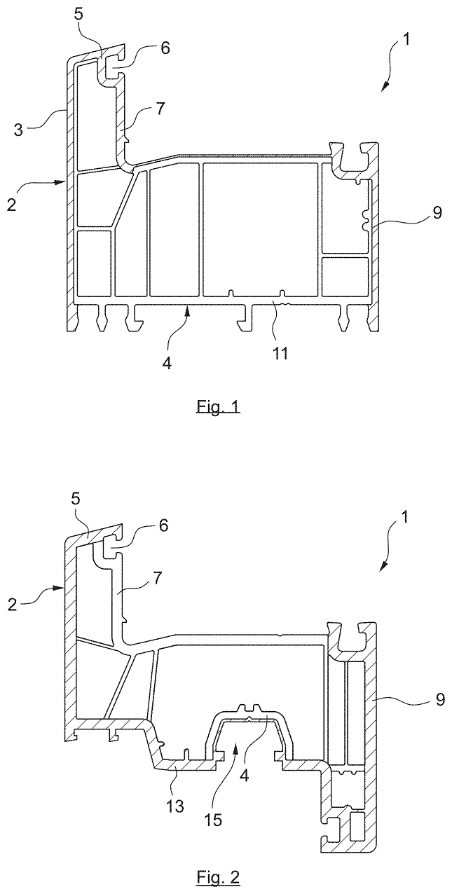

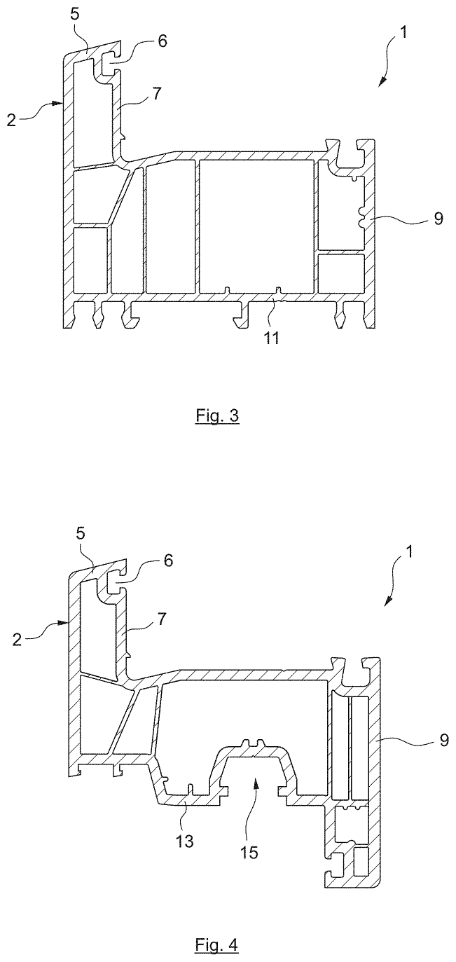

With reference to FIGS. 1 to 4, example embodiments of an extrusion profile according to the disclosure, which is generally designated with reference number 1, are described. The example embodiments of extrusion profiles 1 according to the disclosure in FIGS. 1 to 4 are, for example, extrusion profiles 1 made of plastic, in particular PVC. The extrusion can be performed by means of coextrusion (FIGS. 1 and 2) or by means of monoextrusion (FIGS. 3 and 4). FIG. 1 and FIG. 2 show example embodiments of an extrusion profile 1 according to the disclosure in a sectional view. The example embodiments of an extrusion profile 1 according to the disclosure in FIG. 1 and FIG. 2 are formed as coextrusion profiles. In FIGS. 3 and 4, example embodiments of extrusion profiles 1 according to the disclosure are formed as monoextrusion profiles.

With reference to FIG. 1, an extrusion profile 1 according to the disclosure manufactured by means of coextrusion is described which, for example, forms at least one horizontal or vertical spar of a stationary door and/or window frame part. A profile surface forming an outside of the extrusion profile 1 is designated with the reference number 2. This at least one profile surface 2 forming the outside of the extrusion profile 1 is made of a mixture comprising plastic and at least one pigmented cellulose or of a mixture comprising plastic and at least one mineral. The manufacturing process of the extrusion profile 1 will be discussed in detail later. The at least one profile surface 2 forming the outside of the extrusion profile 1 is additionally marked by a hatching in FIGS. 1 and 2. The profile surface 2 comprises in particular those profile webs of the extrusion profile 1, which are visible to the outside, in particular when the extrusion profile 1 is integrated in the door and/or window frame part. The most relevant profile webs include, for example, a profile outer web 3 to be faced to or facing the surrounding and/or the outside of a building, a sealing web 5 inclined to the profile outer web 3 which is provided to seal a glazing (not shown), an essentially L-shaped glazing web 7 for receiving the glazing, and a profile inner web 9 adjoining the glazing web 7 to be faced to or facing the inside of the building. This ensures that the extrusion profile 1 has the desired look, in particular a concrete look. The glazing web 7 can alternatively be a support web, if the extrusion profile 1 is used for a stationary door and/or window frame part of a sliding system or of a lift and slide system, wherein in this case the support web 7 serves to support or receive the door and/or window wing part movable relative to the door and/or window frame part.

The extrusion profile 1 further comprises a profile base 4 manufactured in one production step with the profile surface 2, in particular by means of coextrusion. The profile base 4 can be made of any plastic material, for example plastic-, in particular PVC-, raw material or a plastic recycling material, such as plastic UWG. From FIG. 1 it becomes clear that the profile base 4 is not visible from the outside, except in the area of a bottom web 11 forming the bottom of the door and/or window frame part. The profile base 4 is, except for the bottom web 11, completely enclosed or framed by the profile surface 2.

In the sectional view in FIG. 1, the extrusion profile 1 has an essentially L-shaped outer contour. The individual profile webs of the profile surface 2 are manufactured in one piece by means of extrusion and have an essentially constant wall thickness and/or cross-sectional dimension along the extrusion direction (into the drawing plane). In the area of the sealing web 5, a sealing reception 6 for a glazing seal (not shown) is provided to seal a sealing gap between the glazing and the sealing web 5 or the glazing web 7.

In its basic structure, the extrusion profile 1 according to FIG. 2 is built and manufactured analogously to the extrusion profile 1 according to FIG. 1. In contrast to FIG. 1 the extrusion profile 1 according to FIG. 2 forms a movable, in particular translationally slidable or pivotable, door and/or window wing part. The extrusion profile 1 for the movable door and/or window wing part according to FIG. 2 is also manufactured by means of coextrusion and comprises a profile surface 2 made of a mixture comprising plastic and at least one pigmented cellulose or of a mixture comprising plastic and at least one mineral as well as a profile base 4 made of any plastic material, wherein the profile base 4 and the profile surface 2 are manufactured in one production step by means of coextrusion. In contrast to the embodiment according to FIG. 1, in the extrusion profile 1 of the door and/or window wing part in FIG. 2, the glazing web 7 is at least partially part of the profile base 4. Another difference is that a fitting web 13 to be faced to a stationary door and/or window frame part, which forms the bottom of the extrusion profile 1, is part of the profile surface 2. The profile surface 2, as well as the profile base 4, have a fitting groove 15 for a fitting of the door and/or window system (not shown).

The advantage of the example embodiment of an extrusion profile according to the disclosure according to FIG. 1 and FIG. 2 is in particular that the at least one profile surface 2 forming the outside of the extrusion profile 1, which is preferably made of a mixture comprising plastic and at least one pigmented cellulose or of a mixture comprising plastic and at least one mineral, is adapted in shape with respect to the bottom of the profile basis 4 forming the bottom of the extrusion profile 1, so that a particularly compact structure is provided. Further, the at least one profile surface 2 forming the outside of the extrusion profile 1 can be dimensioned in a way that it essentially exclusively forms the visible area of the respective profile webs of the extrusion profile 1. The profile base 4 and the profile surface 2 can be form- and/or force-fittingly connected to each other.

In comparison to extrusion profiles that are known in the prior art, in the extrusion profile 1 according to the disclosure, the at least one pigmented cellulose or the at least one mineral can be limited to a single layer of the at least one profile surface 2 forming the outside of the extrusion profile 1, that is made of a mixture comprising plastic and at least one pigmented cellulose or comprising plastic and at least one mineral. This layer comprising plastic and at least one pigmented cellulose or comprising plastic and at least one mineral is preferably located on the visible surface of the profile, thus on the outside facing away from the interior of the building. Despite a small amount of the at least one pigmented cellulose or the at least one mineral being used, the application of a single, thin layer gives the at least one profile surface 2 forming the outside of the extrusion profile, that is displayed with hatching, gives the plastic extrusion profile a concrete look and/or the look of a plastic recycling material.

FIG. 3 and FIG. 4 show further example embodiments of an extrusion profile according to the disclosure in a sectional view, which is generally designated with the reference number 1 and in FIG. 3 and FIG. 4 formed as monoextrusion profile. To avoid repetition, the same components are given the same terminology as in FIGS. 1 and 2.

In contrast to the example embodiment of an extrusion profile according to the disclosure according to FIGS. 1 and 2, in the examples of the extrusion profile 1 according to the disclosure shown in FIG. 3 and FIG. 4, the extrusion profile 1 is made completely of the mixture forming the profile surface 2 comprising plastic and at least one pigmented cellulose or comprising plastic and at least one mineral, namely in one production step by means of monoextrusion. In the embodiment according to FIG. 3, analogously to the embodiment according to FIG. 1, it is an extrusion profile 1 for a stationary door and/or window frame part and in the embodiment according to FIG. 4, analogously to the embodiment according to FIG. 2, it is an extrusion profile 1 for a movable door and/or window wing part. The examples of the extrusion profile 1 according to the disclosure shown in FIG. 3 and FIG. 4 thus have the same concrete look not only on the visible outside of the extrusion profile 1, but also on the inside, due to the addition of the at least one pigmented cellulose or the at least one mineral.

The example embodiment of an extrusion profile 1 according to the disclosure according to FIGS. 3 and 4 show a continuously hatched extrusion profile 1, because in the monoextrusion profile the mixture comprising plastic and at least one pigmented cellulose or at least one mineral is used consistently in the one-piece extrusion profile 1.

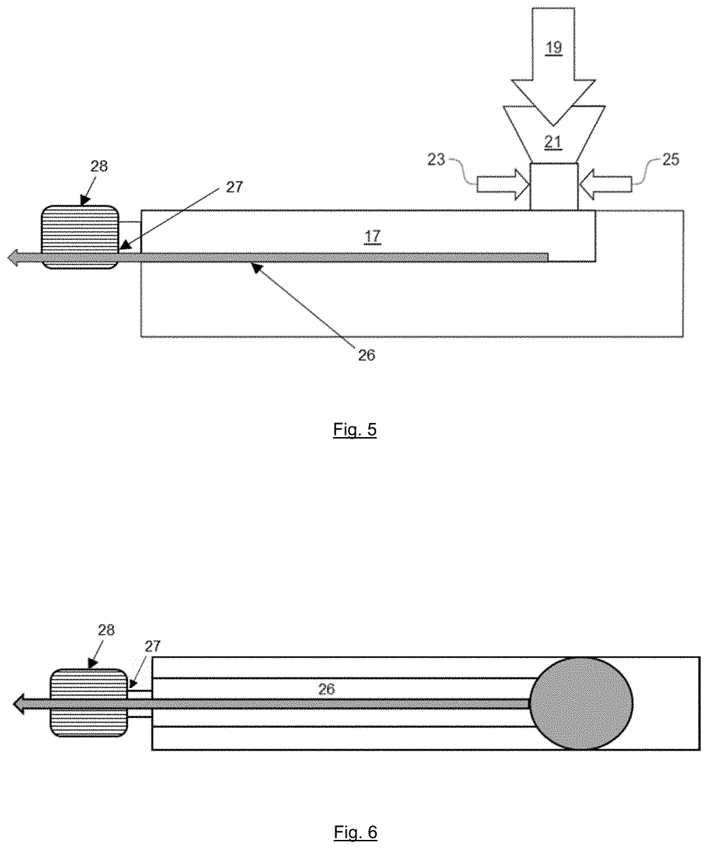

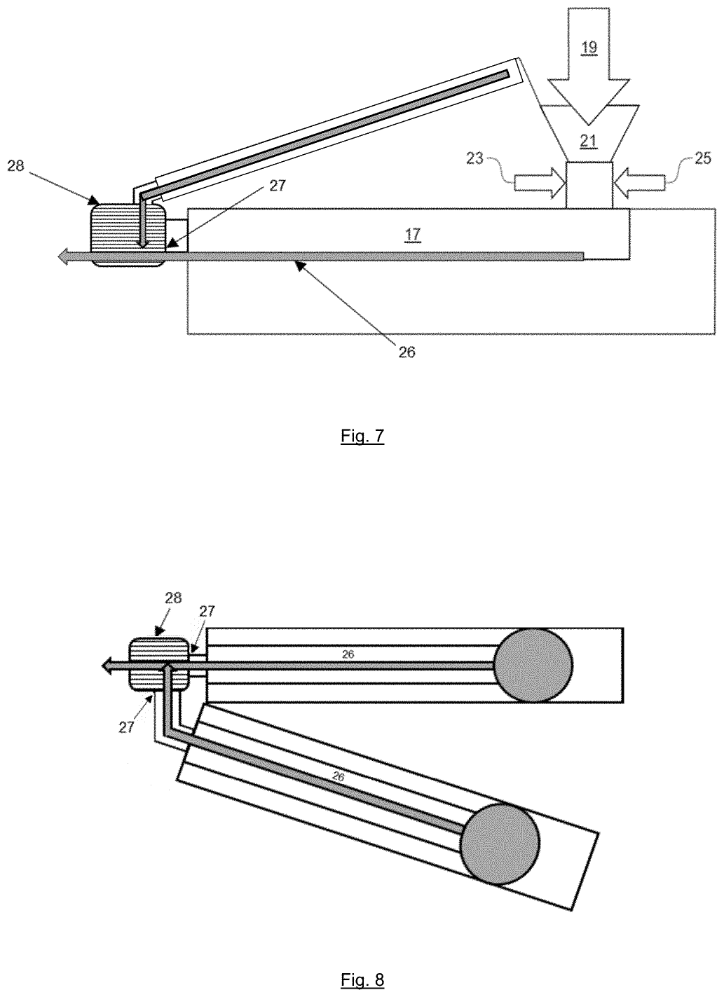

With reference to FIGS. 5 to 10, example embodiments of the manufacturing process for manufacturing an extrusion profile according to the disclosure are described. The example embodiments of the manufacturing process in FIGS. 5 to 10 are, for example, manufacturing processes for extrusion profiles made of plastic, in particular PVC. The extrusion can be performed by means of monoextrusion (FIGS. 5 and 6) or by means of coextrusion (FIGS. 7 to 10).

With reference to FIG. 5, the manufacturing process for manufacturing an extrusion profile 1 according to the disclosure and in particular the production step of adding the at least one pigmented cellulose or the at least one mineral in the extrusion process is shown schematically and explained in more detail in the following: FIG. 5 shows a section of an extrusion line 17 for manufacturing an extrusion profile 1 according to the disclosure in a side view. In an inlet area 19, indicated by the arrow 19, a plastic material is fed in. The plastic material is then further processed according to the disclosure to obtain a concrete-like look and/or the look of a plastic recycling material. For this purpose, the plastic material is passed on by means of a material funnel 21 and receives the desired concrete look and/or the look of plastic recycling material by adding the at least one pigmented cellulose or the at least one mineral in the profile extrusion. According to the disclosure, a dosed addition of the at least one pigmented cellulose or the at least one mineral to the plastic material is performed by means of a metering device, which is indicated schematically by the arrows with the reference numbers 23, 25. The metering device 23, 25 can, for example, be a volumetric and/or a gravimetric metering device.

If the at least one profile surface 2 forming the outside of the extrusion profile is made of a mixture, which comprises plastic and at least one pigmented cellulose or at least one mineral, the metering of the at least one pigmented cellulose or the at least one mineral is performed exclusively via the metering device 23, 25. In an exemplary embodiment, the at least one profile surface 2 forming the outside of the extrusion profile 1 of the extrusion profile 1 for a door and/or window frame part or a door and/or window wing part, can also be made of a mixture comprising plastic, at least one mineral and additionally at least one pigment. In this embodiment, the metering of the at least one mineral is performed via a metering device channel 23, whereas the metering of the pigment is performed via another metering device channel 25. The metering device for both metering device channels 23, 25 can, for example be a volumetric and/or a gravimetric metering device.

According to the disclosure, each pigment can be added via the metering device 23 in the extrusion process. In an exemplary embodiment, a pigment is used which has a “concrete gray” color and/or the color of a plastic recycling material. In an exemplary embodiment, a pigment in RAL 7023 is added in the extrusion process via the metering device 23, 25. By the dosed addition of the at least one pigmented cellulose or the at least one mineral, and optionally by the dosed addition of the at least one additional pigment, in the profile extrusion by means of the metering device 23, 25, the desired coloration can be precisely controlled.

FIG. 6 shows a schematic representation of a section of a production line for a monoextrusion profile according to the disclosure in a top view. The flow direction of the plastic melt is indicated by the gray arrow, which is designated with the reference number 26. The flange for mounting the tool (nozzle) to the extruder is marked with the reference number 27. The extrusion tool (nozzle) in which the extrusion profile is formed, is designated with the reference number 28, and highlighted by a hatching. An essential advantage of the manufacturing process according to the disclosure is that the at least one pigmented cellulose, the at least one mineral and optionally the at least one additional pigment can be limited to a single layer of the profile surface forming the outside of the profile surface. In an exemplary embodiment, this layer is located on the visible surface of the profile, thus on an outside facing away from the interior of a building. Despite a small amount of the at least one pigmented cellulose, the at least one mineral and optionally the at least one additional pigment, the process according to the disclosure makes it possible, due to the layer wise application of the at least one pigmented cellulose, the at least one mineral and optionally the at least one additional pigment, to give the plastic extrusion profile a concrete look and/or the look of a plastic recycling material. This makes it possible to reduce the costs for manufacturing an extrusion profile according to the disclosure, which would arise if a larger amount of the at least one pigmented cellulose, the at least one mineral and optionally the at least one additional pigment is used.

In general, the addition of substances such as at least one pigmented cellulose or at least one mineral to a profile can lead to a reduction in strength of the profile. The manufacturing process according to the disclosure for an extrusion profile 1 enables the application of a thin layer of the at least one pigmented cellulose or the at least one mineral. By applying a thin layer of the at least one pigmented cellulose or the at least one mineral, the addition of the at least one pigmented cellulose or the at least one mineral to the profile has no noticeable strength-reducing effect on the profile, as the addition can be reduced to a single very thin layer. Therefore, the extrusion profiles manufactured according to the disclosure have a sufficient strength both in the welding area, as well as against impact and fracture.

With reference to FIG. 7, the manufacturing process to manufacture an extrusion profile 1 according to the disclosure, in particular a coextrusion profile, as well as particularly the production step of adding the at least one pigmented cellulose or the at least one mineral in the coextrusion process is shown schematically and is explained in more detail in the following. In FIG. 7, the same components are given the same terminology as in FIGS. 1 to 6. FIG. 7 shows a section of an extrusion line 17 for manufacturing an extrusion profile 1 according to the disclosure in a side view. In an inlet area 19, indicated by the arrow 19, the plastic material is fed in. The plastic material is then further processed according to the disclosure to obtain a concrete-like look and/or the look of a plastic recycling material. For this purpose, the plastic material is passed on as plastic melt by means of an material funnel 21 and the combination of the plastic material with additives, such as the at least one pigmented cellulose or the at least one mineral is performed by coextrusion. The two melts are generated by two separate extrusion lines (extruders, 17) and combined to form an extrusion profile in the extrusion tool (nozzle, 28).

In general, two extruders can for example be arranged in a V-arrangement (laterally offset one above the other) or in a piggyback arrangement (directly above one another). According to the disclosure, the two extruders are arranged in such a way that a single- or double-stand tool or two double-stand tools can be connected over the shortest possible paths so that the two melts can be formed into one or two profiles in the tool or in the tools.

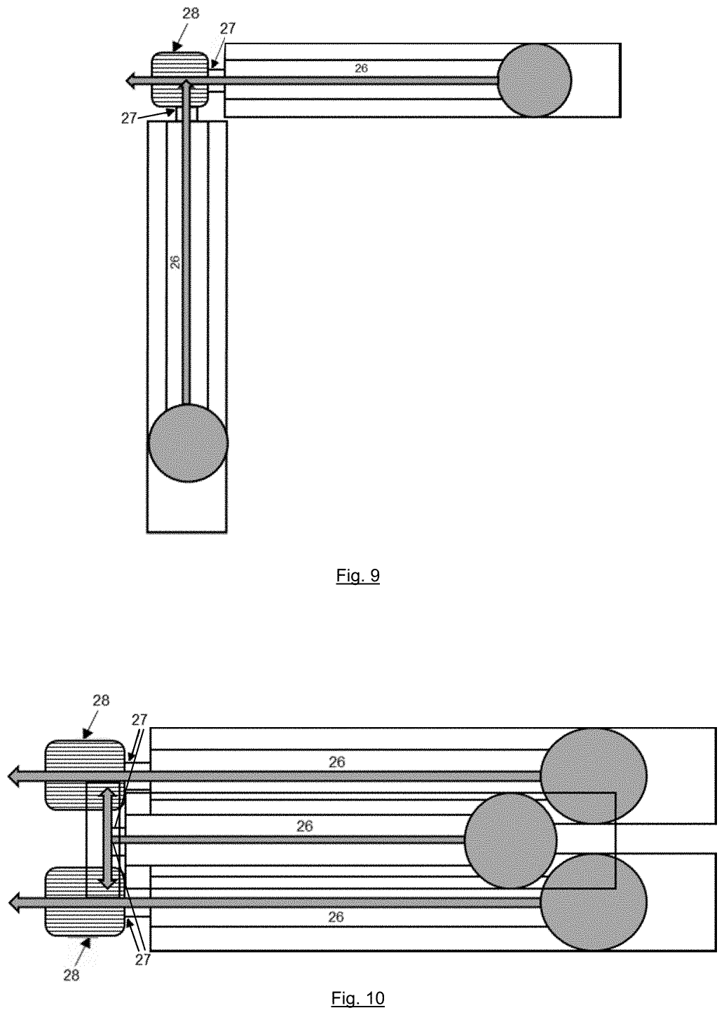

With reference to FIGS. 8 to 10, example embodiments of a manufacturing process for manufacturing an extrusion profile according to the disclosure are described. The example embodiments of the manufacturing process in FIGS. 8 to 10 are different possible arrangements of different extruders in an extrusion line 17. FIG. 8 shows a V-shaped arrangement of two extruders in an extrusion line 17 for a manufacturing process for manufacturing an extrusion profile 1 according to the disclosure in a top view. In a further example embodiment of a manufacturing process for manufacturing a coextrusion profile according to the disclosure, the arrangement of two extruders in an extrusion line 17 for a manufacturing process to manufacture an extrusion profile 1 according to the disclosure is arranged in an L-shape, as shown schematically in FIG. 9 in a top view. FIG. 10 shows a schematic representation of an extrusion line 17 with two tools and three extruders in a top view.

The features disclosed in the above description, the figures and the claims can be important for realizing the disclosure in the various embodiments both individually as well as in any combination.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

1 Extrusion profile
2 Profile surface forming the outside of the extrusion profile
3 Profile outer web
4 Profile base
5 Sealing web
6 Sealing reception
7 Glazing web
9 Profile inner web
11 Bottom web
13 Fitting web
15 Fitting groove
17 Extrusion line
19 Inlet area
21 Material funnel
23 Metering device
25 Metering device
26 Flow direction of the plastic melt
27 Flange for mounting the tool (nozzle) to the extruder
28 Extrusion tool (nozzle)

1. An extrusion profile for a window and/or door part, comprising:
at least one profile surface forming an outside of the extrusion profile being made of a mixture, the mixture including plastic and at least one pigmented cellulose or at least one mineral,
wherein the at least one pigmented cellulose or the at least one mineral has a mass fraction between 1.0 wt.-% and 15.0 wt.-% of the mixture.

2. The extrusion profile according to claim 1, wherein the at least one pigmented cellulose or the at least one mineral has a mass fraction between 2.0 wt.-% and 10.0 wt.-% of the mixture.

3. The extrusion profile according to claim 1, wherein the pigmented cellulose is a pigmented cellulose mixture comprising at least cellulose and at least one pigment, the pigmented cellulose having a mass fraction between 1 wt.-% and 10 wt.-% of the mixture.

4. The extrusion profile according to claim 1, wherein the pigmented cellulose have a mass fraction of 5 wt.-% of the mixture.

5. The extrusion profile according to claim 1, wherein the at least one mineral is magnesium silicate, aluminum magnesium silicate, potassium aluminum silicate, mica, MicaCelia, graphite, slate and/or glass fiber.

6. The extrusion profile according to claim 1, wherein the at least one mineral is magnesium silicate.

7. The extrusion profile according to claim 1, wherein the mineral has a mass fraction between 1.0 wt.-% and 10.0 wt.-% of the mixture.

8. The extrusion profile according to claim 1, wherein the mineral has a mass fraction of 2.5 wt.-% of the mixture.

9. The extrusion profile according to claim 1, wherein the mixture additionally comprises at least one pigment.

10. The extrusion profile according to claim 7, wherein the pigment is a pigment in RAL 7023, RAL 7000, RAL 7001, RAL 7002, RAL 7003, RAL 7004, RAL 7005, RAL 7006, RAL 7008, RAL 7009, RAL 7010, RAL 7011, RAL 7012, RAL 7013, RAL 7015, RAL 7016, RAL 7021, RAL 7022, RAL 7024, RAL 7026, RAL 7030, RAL 7031, RAL 7032, RAL 7033, RAL 7034, RAL 7035, RAL 7036, RAL 7037, RAL 7038, RAL 7039, RAL 7040, RAL 7042, RAL 7043, RAL 7044, RAL 7045, RAL 7046, RAL 7047 and/or RAL 7048.

11. The extrusion profile according to claim 1, wherein the plastic is a plastic recycling material comprising a used-window-granulate or a mixture including plastic and at least one additive, the used-window-granulate or the mixture having plastic and at least one additive has a mass fraction between 70 wt.-% and 100 wt.-% of the mixture.

12. The extrusion profile according to claim 11, wherein the used-window-granulate or the mixture having plastic and at least one additive has a mass fraction of 95 wt.-% of the mixture.

13. The extrusion profile according to claim 11, wherein the at least one additive is calcium carbonate, titanium-(IV)-oxide, a modifier, such as acrylate and/or chlorinated polyethylene (CPE), a stabilizer, a metal soap, a lubricant, a stearate, a fatty acid and/or a pigment.

14. The extrusion profile according to claim 1, wherein the plastic is a polyvinyl chloride plastic.

15. The extrusion profile according to claim 1, wherein metering of the at least one pigmented cellulose or the at least one mineral having been performed by adding the at least one pigmented cellulose or the at least one mineral to the plastic via a metering device.

16. The extrusion profile according to claim 1, wherein the extrusion profile for a window and/or door frame part or a window and/or door wing part.

17. A method for manufacturing an extrusion profile, comprising:
providing a mixture that includes plastic and at least one pigmented cellulose or at least one mineral, the at least one pigmented cellulose or the at least one mineral having a mass fraction between 1.0 wt.-% and 15.0 wt.-% of the mixture; and
extruding the mixture to form the extrusion profile having at least one profile surface forming an outside of the extrusion profile.

18. The method according to claim 17, further comprising performing a metering of the at least one pigmented cellulose or the at least one mineral is by adding the at least one pigmented cellulose or the at least one mineral to the plastic via a metering device.
